(19) United States
(12) Patent Application Publication
(10) Pub. No.: US 2003/0016872 A1
(43) Pub. Date: Jan. 23, 2003

(54) Method of screening a group of images

(76) Inventor: Hung-Ming Sun, Taipei (TW)

Correspondence Address: BIRCH STEWART KOLASCH & BIRCH, PO BOX 747, FALLS CHURCH, VA, 22040-0747, US

(21) Appl. No.: 10/131,197

(22) Filed: Apr. 25, 2002

(30) Foreign Application Priority Data
Jul. 23, 2001 (TW) 90117929

(51) Int. Cl. G06K 9/68

(52) U.S. Cl. 382/218

(57) ABSTRACT

A method of screening a group of images. First, a parameter table is provided, and a number of images to be screened and an expected objective or non-objective group recognition rate are received. Then, an item-set corresponding to the number of images and the objective or non-objective group recognition rate is selected from the parameter table. A single-image recognition method is set with the parameters recorded in the selected item-set, and then the images are screened by the single-image recognition method. Finally, the group of images is identified as an objective group if the number of objective images detected is equal to or larger than the least number of objective images recorded in the selected item-set.

### BACKGROUND OF THE INVENTION

1. Field of the Invention

The present invention relates to a method of screening images, and particularly to a method of screening a group of images that determines the parameters of a recognition method for single image and the least number of objective images that must be detected in the image group. Determination of the parameters and the least objective image number is related to the total number of images to be screened and an expected group recognition rate. The best setting for the single-image recognition method is solved under the given conditions, so that the overall group recognition rate is optimized.

2. Description of the Related Art

In most conventional recognition methods, only a single image can be applied. In one case, the recognition method can set parameters such as sensitivity of recognition, thus performing a logical determination process to screen (recognize) the image and then providing a recognition score or a recognition result (correct or incorrect). In another case, the recognition method compares the content of an image with a characteristic database of an objective image, and provides a recognition score or a recognition result (correct or incorrect) corresponding to the image.

In the situation of recognizing a group of images, for example, screening whether the images attached to an email message are unacceptable or not, the conventional method employs a single-image recognition method to screen every image, and thus each of the images receives a recognition score. Then, the recognition scores of the images are added with different weights to find a global score. Finally, these images are determined to be unacceptable or not based on the global score.

However, in some specific cases, such as a group of images attached to an email message or the images embedded in a webpage, since the images always must be scored individually, the conventional method is time-consuming.

### SUMMARY OF THE INVENTION

It is therefore an objective of the present invention to provide a method of screening a group of images that determines the parameters of a recognition method for single image and the least number of objective images that must be captured in an image group. The parameters of a recognition method and the least number of objective images are determined according to the number of images to be screened and an expected group recognition rate.

Another objective of the present invention is to provide a method of screening a group of images that maximizes the recognition rate under limitation of an acceptable false-alarm rate.

The present invention includes a parameter table. The parameter table has a plurality of item-sets, which store parameters of a single-image recognition method and the least number of images that must be recognized by the single-image recognition method. The item-sets are indexed via the number of images input for screening and either the desired group recognition rate or the desired false-alarm rate. If the recognition rate is chosen for indexing, it minimizes the corresponding false-alarm rate. On the other hand, if the false-alarm rate is chosen for indexing, it maximizes the corresponding group recognition rate.

Given a group of images for screening, the item-set corresponding to the number of images and the desired group recognition rate is selected from the parameter table. The single-image recognition method is set with the parameters recorded in the selected item-set, and then the images are screened individually by the single-image recognition method.

During image screening, the objective images detected are counted. If the count of the detected objective images is equal to or higher than the least number of images recorded in the item-set, the group of images is determined immediately to be an objective image group no matter whether all of the images are examined. On the contrary, if the count of the captured objective images is less than the least number of images recorded in the item-set after checking all the images, the image group is identified as non-objective.

According to the embodiment, the group recognition rate can be an objective-group recognition rate or a non-objective-group recognition rate (for indexing via false-alarm rate). Both kinds of group recognition rates can be computed from the objective and non-objective recognition rate of a single-image recognition method.

Further, the single-image recognition method may be a logical determination method and/or a characteristic comparison method.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flow chart illustrating the operation of a method of screening a group of images according to the embodiment of the present invention.

### DETAILED DESCRIPTION OF THE PREFERRED EMBODIMENT

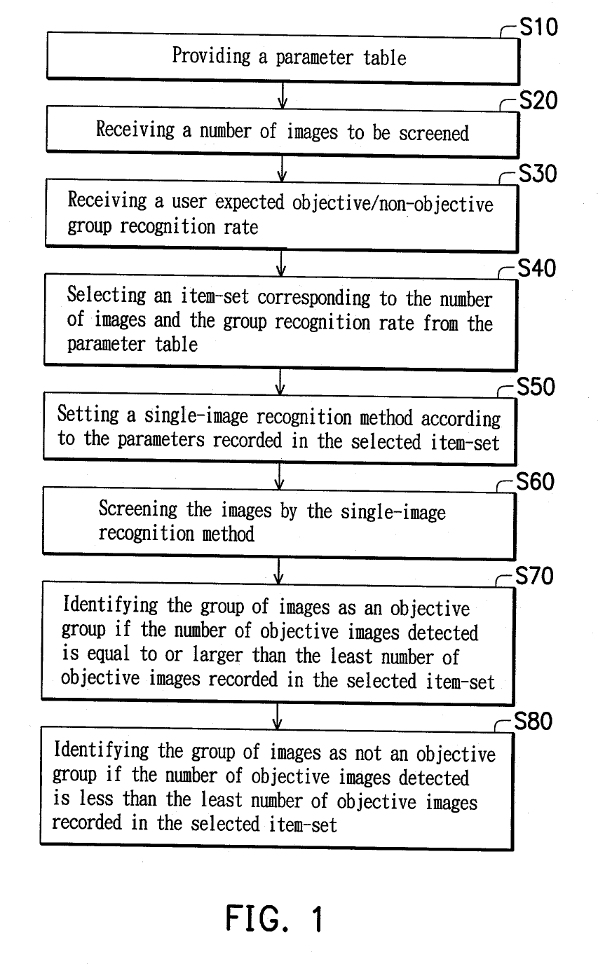

FIG. 1 shows a flow chart illustrating the operation of a method of screening a group of images according to the embodiment of the present invention. Referring to FIG. 1, the embodiment of the present invention is described as follows.

Parameter Table

First, in step S10, a parameter table is provided. The parameter table has a plurality of item-sets, each of which records parameters for setting a single-image recognition method and the least number of images that must be recognized by the single-image recognition method. The item-sets are indexed via the number of images input for screening and either the desired group recognition rate or the desired false-alarm rate.

For example, if the number of images to be screened is 3 and the expected objective group recognition rate is 80%, then the parameter table has an item-set corresponding to these conditions (image number=3 and objective group recognition rate=80%), and the item-set describes the parameters for setting the single-image recognition method and the least number of images that must be recognized by the single-image recognition method. Then, the single-image recognition method is set with the parameters, and starts to examine the images.

Further, the group recognition rate can be an objective-group recognition rate or a non-objective-group recognition rate. The objective-group recognition rate represents the probability that a group of objective images is correctly identified, and the non-objective-group recognition rate represents the probability that a group of non-objective images is correctly rejected.

The group recognition rate recorded in each of the item-sets is an optimal group recognition rate. For example, the item-set indexed with (image number=3, objective group recognition rate=80%) promises theoretically that the false-alarm rate is also the lowest (or correspondingly, the non-objective group recognition rate is the highest) under such conditions. The computation of the item-sets is described below.

The recognition rate of a single-image recognition method is represented as follows:

Recognition Rate=(p_{s,i},q_{s,i},Ti)

where p_{s,i} denotes the objective recognition rate of the single-image recognition method; q_{s,i} denotes the non-objective recognition rate of the single-image recognition method; Tᵢ denotes the parameters used to set the single-image recognition method for achieving (p_{s,i},q_{s,i}). Change of Tᵢ may cause change of (p_{s,i},q_{s,i}). Hence a single-image recognition method can have many different sets, i.e. i=1,2,3, . . . of performance.

Suppose that the number of images to be screened is n, and a group recognition rate is represented as follows:

Group Recognition Rate=(p_{g,i},q_{g,i},Tᵢ,mᵢ)

where p_{g,i} denotes the objective-group recognition rate; q_{g,i} denotes the non-objective-group recognition rate; Tᵢ denotes the parameters used to set the single-image recognition method for achieving (p_{g,i},q_{g,i}); mᵢ, 0≦mᵢ≦n, denotes the least number of images that must be identified as objective images in the n images.

If the input is a group of n objective images, then it is correctly recognized as a objective image group only when the number of images identified as objectives is equal to or more than mᵢ. Therefore, p_{g,i} can be calculated by

$${p}_{g , i} = ( \begin{matrix}n \\ {m}_{i}\end{matrix} ) {{p}_{s , i}^{{m}_{i}} ( 1 - {p}_{s , i} )}^{n - {m}_{i}} + ( \begin{matrix}n \\ {m}_{i} + 1\end{matrix} ) {{p}_{s , i}^{{m}_{i} + 1} ( 1 - {p}_{s , i} )}^{n - {m}_{i} - 1} + … + ( \begin{matrix}n \\ n\end{matrix} ) {p}_{s , i}^{n} \qquad ( 1 )$$

In a similar manner, if the input is a group of n non-objective images, then it is correctly recognized as a non-objective image group only when the number of images identified as non-objectives is less than mᵢ. Thus, q_{g,i} can be calculated by

$${q}_{g , i} = ( \begin{matrix}n \\ 0\end{matrix} ) {q}_{s , i}^{n} + ( \begin{matrix}n \\ 1\end{matrix} ) {q}_{s , i}^{n - 1} ( 1 - {q}_{s , i} ) + … + ( \begin{matrix}n \\ {m}_{i} - 1\end{matrix} ) {{q}_{s , i}^{n - {m}_{i} + 1} ( 1 - {q}_{s , i} )}^{{m}_{i} - 1} \qquad ( 2 )$$

From Eqs. (1) and (2), the values of p_{g,i} and q_{gi} depend on n, mᵢ,p_{s,i} and q_{s,i}. Furthermore, p_{s,i} and q_{s,i} depend on Tᵢ. Hence, p_{g,i} and q_{g,i} are both functions of n, mᵢ, and Tᵢ in soul. That is, tuning the single-image recognition method and the value mᵢ under a specific n will change the group recognition rates p_{g,i} and q_{g,i}.

Given n and p_{g,i}, different values of mᵢ and Tᵢ can be used to calculate the quantities of p_{g,i} and q_{g,i} by Eqs. (1) and (2) and there is only one combination which can yield the largest q_{g,i}. This is the best pair of mᵢ and Tᵢ for the given n and p_{g,i}, and they are chosen. Note that, for a specific single-image recognition method, the best sets of (p_{g,i}, q_{g,i},Tᵢ,mᵢ) i=1, 2, 3, . . . will not vary. Therefore, the best sets can be pre-calculated and stored into a parameter table to avoid repeated computation. If the given values are n and q_{g,i} a similar manner can be used to solve for the corresponding best sets.

Operation flow

Next, in steps S20 and S30, a number of images to be screened and an expected group recognition rate are received. The received group recognition rate may be an objective-group recognition rate or a non-objective-group recognition rate. Then, in step S40, the item-set corresponding to the number of images and the group recognition rate is selected from the parameter table.

In step S50, the single-image recognition method is set according to the parameters recorded in the selected item-set, and in step S60, the images are screened by the single-image recognition method one by one, and an individual recognition result, i.e. objective or non-objective, is given to each of the images.

Finally, in step S70, the group of images is identified as an objective group if the number of objective images detected is equal to or larger than the m value stored in the item-set (i.e. the least number of objective images), and in step S80, the group of images is identified as a non-objective group if the number of objective images detected is less than the m value stored in the item-set.

It should be noted that, step S70 can be performed after all the images are screened, or after a new objective image is captured. The latter can increase processing speed because not all images need to be recognized for an objective image group.

Further, the single-image recognition method can be a logical determination method and/or a characteristic comparison method, but not limited to both.

As a result, the present invention describes a method of screening a group of images and it can determine optimal parameters for setting a single-image recognition method and the least number of objective images that must be captured in the image group, so as to improve the global recognition rate for image groups and also speed up the processing.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method of screening a group of images, comprising the steps of:
receiving a group of images, say N, to be screened;
receiving an expected group recognition rate, say R;
determining the parameter set T for screening the images and the least number of objective images M that must be detected based on N and R;
screening the images individually with T; and
identifying the group of images as an objective group by comparison between M and the number of detected objective images in the image group.

2. The method as claimed in claim 1 wherein the expected group recognition rate R can be objective group recognition rate and non-objective group recognition rate.

3. The method as claimed in claim 1 wherein the determination of the parameter set T and the least number of objective images M can be achieved by screen a pre-computed parameter table, which has a plurality of item-sets recording different combination of T and M for various cases.

4. The method as claimed in claim 1 further identifies the group of images as a non-objective group if it is not identified as an objective group.

5. The method as claimed in claim 3 wherein the item-sets can be indexed by the number of images to be screened, the objective group recognition rate, and the non-objective group recognition rate.

6. The method as claimed in claim 1 wherein the single-image recognition method is a logical determination method.

7. The method as claimed in claim 1 wherein the single-image recognition method is a characteristic comparison method.
